(19) United States
(12) Patent Application Publication
(10) Pub. No.: US 2026/0015523 A1
(43) Pub. Date: Jan. 15, 2026

(54) CMP COMPOSITION INCLUDING AMINOSILANE MODIFIED SILICA COATED CERIA PARTICLES

(71) Applicant: ENTEGRIS, INC., Billerica, MA (US)

(72) Inventors: William J. Ward, Aurora, IL (US); Steven Kraft, Aurora, IL (US); Steven Grumbine, Aurora, IL (US); Qiang Zhao, Woodridge, IL (US)

(21) Appl. No.: 19/266,643

(22) Filed: Jul. 11, 2025

Related U.S. Application Data
(60) Provisional application No. 63/670,444, filed on Jul. 12, 2024.

(51) Int. Cl. C09G 1/02; C09K 3/14

(52) U.S. Cl. CPC C09G 1/02; C09K 3/1436

(57) ABSTRACT

A chemical mechanical polishing composition comprises, consists of, or consists essentially of an aqueous based liquid carrier and silica coated ceria particles in the liquid carrier. The silica coated ceria particles include a silica coating over a ceria core and an aminosilane compound covalently bonded to an external surface of the silica coating such that the silica coated ceria particles have a positive charge in the polishing composition. The pH of the composition is less than about 7.

### BACKGROUND OF THE INVENTION

Chemical mechanical polishing (CMP) compositions and methods for polishing (or planarizing) the surface of a substrate are well known. Polishing compositions (also known as polishing slurries, CMP slurries, and CMP compositions) for dielectric layers (such as silicon oxide) on a semiconductor substrate may include abrasive particles suspended in an aqueous solution and various chemical additives such as polishing rate accelerators, topography control agents, buffers, and the like.

In a conventional CMP operation, the substrate (wafer) to be polished is mounted on a carrier which is in turn mounted on a carrier assembly and positioned in contact with a polishing pad in a CMP polishing tool. The carrier assembly provides a controlled pressure to the substrate against the polishing pad. The substrate and pad are moved relative to one another by an external driving force. The relative motion of the substrate and pad abrades and removes a portion of the material from the surface of the substrate, thereby polishing the substrate. The polishing of the substrate by the relative movement of the pad and the substrate may be further aided by the chemical activity of the polishing composition and/or the mechanical activity of an abrasive suspended in the polishing composition.

In many CMP operations achieving optimum removal rates and minimal defects is desired. For example, in advanced dielectric CMP operations high removal rates are desired to maintain throughput and low defect counts are desired to maintain a high yield. However, achieving high removal rates and low defect counts can be challenging. For example, ceria abrasive compounds are commonly used to achieve high removal rates but can also be prone to imparting surface defects. Despite many advances to commercial CMP compositions, there remains a need in the industry for CMP compositions that provide high dielectric removal rates and reduced defects during a CMP operation.

### BRIEF SUMMARY OF THE INVENTION

A chemical mechanical polishing composition is disclosed. The composition comprises, consists of, or consists essentially of a liquid carrier; silica coated ceria particles in the liquid carrier, the silica coated ceria particles having a silica coating over a ceria core; an aminosilane compound covalently bonded to an external surface of the silica coating such that the silica coated ceria particles have a positive charge in the polishing composition; and a pH of less than about 7.

### BRIEF DESCRIPTION OF THE DRAWINGS

For a more complete understanding of the disclosed subject matter, and advantages thereof, reference is now made to the following descriptions taken in conjunction with the accompanying drawings, in which:

FIG. 1 is a scanning transmission electron microscope (STEM) image of example silica coated ceria particles disclosed herein.

FIG. 2 is a scanning electron microscope (SEM) image of the same example silica coated ceria particles shown in FIG. 1.

### DETAILED DESCRIPTION OF THE INVENTION

Chemical mechanical polishing compositions and methods for formulating and using those compositions to polish a substrate are disclosed. In one example embodiment, a chemical mechanical polishing composition comprises, consists essentially of, or consists of an aqueous based liquid carrier and silica coated ceria particles in the liquid carrier. The silica coated ceria particles include a silica coating over a ceria core and an aminosilane compound covalently bonded to an external surface of the silica coating such that the silica coated ceria particles have a positive charge in the polishing composition. The pH of the composition is less than about 7.

A method for formulating a chemical mechanical polishing composition includes forming a silica coating on outer surfaces of ceria particles dispersed in a liquid carrier to obtain a dispersion of silica coated ceria particles. The silica coated ceria particles are modified (covalently bonded) with an aminosilane compound to obtain the polishing composition including a dispersion of aminosilane modified silica coated ceria particles.

A method for polishing a dielectric containing substrate includes contacting the substrate with the polishing composition, moving the polishing composition relative to the substrate, and abrading the substrate to remove a portion of a dielectric material from the substrate and thereby polish the substrate.

The polishing composition contains aminosilane modified silica coated ceria particles in (e.g., dispersed in) in a liquid carrier. As used herein the aminosilane modified silica coated ceria particles refer to silica coated ceria particles that are modified (e.g., covalently bonded with) an aminosilane compound. The silica coated ceria particles may include ceria particles (e.g., substantially any suitable ceria particles) that have a thin layer of silica (the silica coating) on a substantial portion of the external surfaces of the ceria particles. The aminosilane compound is bonded to external surfaces of the silica coating. The aminosilane modified silica coated ceria particles have a positive zeta potential in the polishing composition and may sometimes have a high zeta potential similar that of hypothetical ceria particles in the polishing composition.

The polishing composition may include substantially any suitable amount of the aminosilane modified silica coated ceria particles. For example, the polishing composition may include about 0.001 wt. % or more of the particles at point of use (e.g., about 0.01 wt. % or more, about 0.03 wt. % or more, about 0.05 wt. % or more, about 0.1 wt. % or more, or about 0.2 wt. % or more). The polishing composition may include about 2 wt. % or less of the particles at point of use (e.g., about 1.5 wt. % or less, about 1 wt. % or less, about 0.75 wt. % or less, or about 0.5 wt. % or less) Accordingly, it will be understood that the amount of aminosilane modified silica coated ceria particles may be in a range bounded by any two of the aforementioned endpoints, for example, in a range from about 0.001 wt. % to about 2 wt. % at point of use (e.g., from about 0.01 wt. % to about 1 wt. %, from about 0.1 wt. % to about 1 wt. %, or from about 0.2 wt. % to about 1 wt. %).

The disclosed aminosilane modified silica coated ceria particles may contain substantially any suitable ceria particles, for example, including wet process ceria, precipitated ceria, fumed ceria, sintered (calcined) ceria, and/or condensation polymerized ceria particles. By ceria particles it is meant particles that are primarily or mostly ceria. Suitable ceria particles may also include doped ceria particles or ceria particles including small amounts (such as a few percent) of other elements or compounds, such as other oxides. Ceria particles suitable for polishing substrates are well known in the CMP industry and are commercially available.

The ceria particles in the disclosed compositions may have substantially any particle size suitable for CMP operations. For example, the ceria particles may be characterized as having an average particle size (such as a weight average particle size or a number average particle size) greater than about 1 nm (e.g., greater than about 5 nm). Moreover, the ceria particles may be characterized as having an average particle size less than about 1 μm (e.g., less than about 500 nm). Accordingly, the ceria particles may be characterized as having an average particle size in a range from about 1 nm to about 1 μm (e.g., from about 5 nm to about 500 nm).

In preferred embodiments, the ceria particles may have a number average particle size of about 20 nm or more (e.g., about 30 nm or more, about 40 nm or more, or about 50 nm or more). Alternatively, in preferred embodiments, the ceria particles may have a number average particle size of about 400 nm or less (e.g., about 300 nm or less, about 200 nm or less, or about 100 nm or less). Accordingly, in such preferred embodiments, the ceria particles may have a number average particle size within a range bounded by any two of the aforementioned endpoints. For example, the first ceria particles may have an average particle size of about 20 nm to about 400 nm (e.g., about 30 nm to about 300 nm, about 40 nm to about 200 nm, or about 50 nm to about 100 nm). In such embodiments, the ceria particle size may be as measured using a CPS Disc Centrifuge Particle size analyzer. In certain advantageous embodiments, the ceria particles are wet process ceria particles or calcined ceria particles and have a number average particle size of less than about 100 nm.

It will be appreciated that the thickness of the silica coating is generally much less than the diameter of the ceria particles. Therefore, it will be further appreciated that the average particle size of the silica coated ceria particles or the aminosilane modified silica coated ceria particles may similar to (e.g., about the same as) the ceria particles. Accordingly, the aminosilane modified silica coated ceria particles may be characterized as having an average particle size in a range from about 1 nm to about 1 μm (e.g., from about 5 nm to about 500 nm). In preferred embodiments, the aminosilane modified silica coated ceria particles may be characterized as having an average particle size in a range from about 20 nm to about 400 nm (e.g., about 30 nm to about 300 nm, about 40 nm to about 200 nm, or about 50 nm to about 100 nm) as measured using a CPS Disc Centrifuge Particle size analyzer.

In some example embodiments, the disclosed polishing composition may include a blend of large and small ceria particles. For example, in some example embodiments, the large ceria particles may include calcined ceria particles and the small ceria particles may include wet-process ceria particles. The large ceria particles may have a number average particle size of about 100 nm or greater and the small ceria particles may have a number average particle size of about 100 nm or less. Moreover, the large and small ceria particles may be present in the polishing composition at any suitable weight ratio.

The aminosilane modified silica coated ceria particles may include substantially any suitable silica coating. By silica coating it is meant that the particles have a thin layer or covering of silica over the ceria particles. The silica coating may also be thought of as a silica shell or silica skin over the ceria particles. By silica coating it is not meant discrete silica particles coupled with or attached to ceria particles. In other words, the silica coating is not merely discrete silica particles that are joined with or otherwise coupled or attached to the outer surface of the ceria particles. However, it will be appreciated that the disclosed embodiments are not limited to aminosilane modified silica coated ceria particles for which the silica coating has a uniform or near uniform thickness. In some embodiments, the silica coating may be non-uniform, having relatively thick and relatively thin regions. In such example embodiments, the silica coating may appear bumpy or knobby in SEM images indicating a possible nucleated growth mechanism.

In example embodiments the silica coating may be formed on the ceria particles. For example, the silica coating may be formed by admixing a silica producing compound to a mixture of ceria particles and a liquid carrier thereby causing a silica coating to form on the external surface of the ceria particles. The silica producing compound may include, for example, tetramethyl orthosilicate (TMOS), tetraethyl orthosilicate (TEOS), silicic acid, an alkali or ammonium silicate, or a silicon tetrahalide. In such embodiments, the particles may be thought of as having a core-shell structure in which a ceria core includes the ceria particles originally added to the liquid solution and the silica coating includes the silica that is formed over the core.

The silica coating may include substantially any suitable precipitated silica or Stöber silica. In preferred embodiments, the silica coating is a Stöber silica. In most preferred embodiments, the silica coating is a high purity Stöber silica such that the aminosilane modified silica coated ceria particles have a high purity. By high purity it is meant that the aminosilane modified silica coated ceria particles may advantageously have a total metals impurity (in which the metals include sodium, aluminum, calcium, magnesium, and the transition metals) of less than 20 parts per million (e.g., less than 15 ppm, less than 10 ppm, less than 5 ppm, less than 2.5 ppm, or less than 1 ppm). In such embodiments, the particles may be potassium or ammonia stabilized. The aminosilane modified silica coated ceria particles may further have a total metals impurity (in which the metals include potassium, sodium, iron, aluminum, calcium, magnesium, titanium, nickel, chromium, copper, and zinc) of less than 20 parts per million (e.g., less than 15 ppm, less than 10 ppm, less than 5 ppm, less than 2.5 ppm, or less than 1 ppm). In such embodiments, the particles may be ammonia or amine stabilized.

The aminosilane modified silica coated ceria particles may have substantially any amount of the silica coating. The amount of silica coating may be quantified, for example, as a coating thickness or an average coating thickness. In example embodiments the silica coating has an average thickness of at least 0.5 nm (e.g., at least 1 nm or at least 2 nm). Alternatively, or in addition, the silica coating may have an average thickness of less than about 20 nm (e.g., less than about 15 nm, less than about 10 nm, or less than about 8 nm). Accordingly, the silica coating may have an average thickness within a range bounded by any two of the aforementioned endpoints. For example, the average thickness of the silica coating may be in a range from about 0.5 nm to about 20 nm (e.g., about 1 nm to about 15 nm, about 1 nm to about 10 nm, or about 2 nm to about 8 nm).

The amount of the silica coating may also be quantified as an average molar quantity of (or a number of) silicon atoms per unit surface area of the aminosilane modified silica coated ceria particles (e.g., mol/m²). It will be appreciated that amount of silicon added in the aminosilane covalently bonded to the silica coating is generally insignificant as compared to the amount of silicon in the silica coating. In example embodiments, the aminosilane modified silica coated ceria particles may contain at least about 1×10⁻⁵ moles of silicon atoms per meter squared (e.g., at least about 2×10⁻⁵ mol/m², at least about 3×10⁻⁵ mol/m², at least about 4×10⁻⁵ mol/m², or at least about 5×10⁻⁵ mol/m²). Alternatively, and/or additionally, the particles may contain less than about 1×10⁻³ mol/m² of silicon per square meter of surface area (e.g., less than about 7×10⁴ mol/m², less than about 5×10⁴ mol/m², less than about 3×10⁴ mol/m², or less than about 2×10⁻⁴ mol/m²). Accordingly, the particles may contain an average molar quantity of silicon atoms per unit surface area within a range bounded by any two of the aforementioned endpoints. For example, the silica coating may contain from about 1×10⁻⁵ mol/m² to about 1×10⁻³ mol/m² silicon (e.g., from about 2×10⁻⁵ mol/m² to about 5×10⁻⁴ mol/m² or from about 3×10⁻⁵ mol/m² to about 3×10⁻⁴ mol/m²).

It will be appreciated that the amount of silica (e.g., the molar quantity of silicon atoms) may be quantified by digesting the aminosilane modified silica coated ceria particles in a concentrated KOH solution and measuring the corresponding concentration of elemental silicon via inductively coupled plasma (ICP). The amount of measured silicon may then be divided by the measured surface area of the ceria particles or the aminosilane modified silica coated ceria particles to obtain a measured amount of silicon in the silica coating (the surface area may be measured as described in Colloids and Surfaces A: Physicochem. Eng. Aspects 322 (2008) 248-252).

The amount of silica (e.g., the molar quantity of silicon atoms) may also be quantified based upon the amount of the silica producing compound used in the synthesis of the silica coated ceria particles (e.g., the amount of TEOS). For example, the total number of moles of silicon in the silica producing compound may be divided by the total surface area of the ceria particles or the aminosilane modified silica coated ceria particles to obtain a theoretical amount of silicon in the silica coating. In example embodiments it may be assumed that 100 percent of the silica producing compound reacts to form the silica coating. In other example embodiments, it may be assumed that less than 100 percent (e.g., about 90 percent, about 80 percent, or about 70 percent) of the silica producing compound reacts to form the silica coating.

In example embodiments, the silica coated ceria particles in the polishing composition are substantially all silica coated ceria particles. In other words, the polishing composition does not include a significant amount of ceria particles or silica particles other than the silica coated ceria particles. By significant amount it is meant that less than about 1 percent (number fraction) of the abrasive particles (e.g. less than about 0.5%) are ceria particles or silica particles (non-silica coated ceria particles).

In other example embodiments, the polishing composition does not include a significant amount of fine (very small) particles. By fine it is meant particles having a particle diameter in a range from about 5 nm to about 25 nm. By significant amount it is meant that less than about 1 percent (number fraction) (e.g., less than about 0.5 percent or less than about 0.3 percent) of the abrasive particles are fine. The number of fine particles may be measured, for example, using differential mobility analysis (DMA).

The modifying aminosilane compound may include substantially any suitable aminosilane compound, for example, including primary aminosilanes, secondary aminosilanes, tertiary aminosilanes, quaternary aminosilanes, and multi-podal (e.g., dipodal) aminosilanes. The aminosilane compound may include substantially any suitable aminosilane, for example, a propyl group containing aminosilane, or an aminosilane compound including a propyl amine. Examples of suitable classes of aminosilanes may include bis(2-hydroxyalkyl)-3-aminoalkyl trialkoxysilane, dialkylaminoalkyltrialkoxysilane (e.g., dialkylaminoalkoxysilane), (N,N-dialkyl-3-aminoalkyl)trialkoxysilane), 3-(N-styrylalkyl-2-aminoalkylaminoalkyl trialkoxysilane, aminoalkyl trialkoxysilane, (2-N-benzylaminoalkyl)-3-aminoalkyl trialkoxysilane), trialkoxysilyl alkyl-N,N,N-trialkyl ammonium, N-(trialkoxysilylalkyl)benzyl-N,N,N-trialkyl ammonium, (bis(alkyldialkoxysilylalkyl)-N-alkhyl amine, bis(trialkoxysilylalkyl)urea, bis(3-(trialkoxysilyl)alkyl)-ethylenediamine, bis(trialkoxysilylalkyl)amine, bis(trialkoxysilylalkyl)amine, 3-aminoalkyltrialkoxysilane, N-(2-aminoalkyl)-3-aminopropylmethyldialkoxysilane, N-(2-aminoalkyl)-3-aminoalkyltrialkoxysilane, 3-aminoalkylmethyldialkoxysilane, 3-aminoalkyltrialkoxysilane, (N-trialkoxysilylalkyl)polyethyleneimine, trialkoxysilylalkyldiethylenetriamine, N-phenyl-3-aminoalkyltrialkoxysilane, N-(vinylbenzyl)-2-aminoalkyl-3-aminoalkyltrialkoxysilane, 4-aminoalkyltrialkoxysilane, and mixtures thereof.

In preferred embodiments, the highly modified colloidal silica particles may be modified with a multi-podal (e.g., dipodal) aminosilane, such as bis(trialkoxysilyl)ethane, bis(trialkoxysilylalkyl)amine (e.g., bis(trialkoxysilylalkyl) amine or bis(trialkoxysilylpropyl) amine), N-(hydroxyalkyl)-N,N-bis(trialkoxysilylalkyl)amine, N,N′-bis[(3-trialkoxysilyl)alkyl]ethylenediamine, N,N′-bis(2-hydroxyalkyl)-N,N′-bis(trialkoxysilylalkyl)ethylenediamine, tris(trialkoxysilylalkyl)amine, 1,11-bis(trialkoxysilyl)-4-oxa-8-azaundecan-6-ol, and mixtures thereof. Those of ordinary skill in the art will readily appreciate that aminosilane compounds are commonly hydrolyzed (or partially hydrolyzed) in an aqueous medium. Thus, by reciting an aminosilane compound, it will be understood that the modifying aminosilane may include a hydrolyzed (or partially hydrolyzed) species and/or condensed species thereof.

In example embodiments, the aminosilane modified silica coated ceria particles may have a modification level of the aminosilane compound on the silica coating of at least about 10 percent (e.g., at least about 12 percent, at least about 14 percent, at least about 16 percent, at least about 18 percent, or at least about 20 percent) to achieve the desired polishing results and colloidal stability. Moreover, the aminosilane modified silica coated ceria particles may have a modification level of less than or equal to about 50 percent (e.g., less than or equal to about 45 percent, or less than or equal to about 40 percent) to promote colloidal stability. Accordingly, the aminosilane modified silica coated ceria particles may have a percent theoretical surface coverage that is in a range from about 10 percent to about 50 percent (e.g., from about 12 percent to about 45 percent or from about 16 percent to about 40 percent).

The modification level of the aminosilane compound may computed from the amount of aminosilane utilized during particle synthesis or may be measured. The disclosed embodiments are not limited in this regard. For example, the modification level may be computed from the molar amount of amino silane used, the measured surface area of the ceria particles (or silica coated ceria particles), the number of silane groups in the aminosilane compound (e.g., 1, 2, or 3), and an assumption that the average number of surface silanol groups on the silica coating is 4.5 per nm².

Alternatively, and/or additionally, the modification level of the aminosilane modified silica coated ceria particles may be measured using the following procedure. The polishing composition may first be passed through a mixed bed ion exchange column to remove unbound or loosely bound aminosilane from the colloidal silica particles. After ionic exchange, the total aminosilane concentration in the polishing composition (both bound and unbound) may be determined by digesting the composition (including the aminosilane modified silica coated ceria particles) in concentrated potassium hydroxide and evaluating the digested composition using proton NMR. The amount of unbound (e.g., dissolved) aminosilane in the polishing composition may be determined by first removing the modified colloidal silica particles from the composition by ultra-centrifugation (e.g., at 40,000 rpm for 1 h) and then testing the decanted liquid layer using liquid chromatography mass spectrometry (LCMS) (for aminosilane concentrations in a range from about 1 to about 100 ppm) and/or NMR (for aminosilane concentrations in a range from about 100 to about 5000 ppm). The amount of bound (modifying) aminosilane may be calculated as the difference between the measured total aminosilane and the measured unbound aminosilane. The modification level may then be calculated based upon the concentration of the aminosilane modified silica coated ceria particles in the polishing composition and the measured surface area thereof. For the purposes of this calculation the average number of surface silanol groups on the silica coating is assumed to be 4.5 per nm².

The modification level of the aminosilane modified silica coated ceria particles is sufficiently high such that the particles have a positive charge in the polishing composition. For example, the modification level may be sufficiently high such that the particles have a zeta potential in the polishing composition of about 20 mV or more (e.g., about 30 mV, about 40 mV or more, about 50 mV or more, or even about 60 mV or more). The zeta potential of the aminosilane modified silica coated ceria particles is measured using the Zetaprobe Analyzer® available from Colloidal Dynamics.

In example embodiments the modification level of the aminosilane compound may be sufficiently high such that the isoelectric point (IEP) of the aminosilane modified silica coated ceria particles is at least about 6 (e.g., at least about 7). For the purposes of this disclosure the IEP is measured on the aminosilane modified silica coated ceria particles before the addition of other polishing composition compounds. The IEP is determined by titrating a sample using the electroacoustic method (e.g., via a Colloidal Dynamics Zetaprobe®). A diluted sample is titrated with 0.1N potassium hydroxide for a base titration (sample pH to 10.5). The zeta potential is measured at least every 0.5 pH units during the titration. The IEP is identified by determining the pH value at which the zeta potential is 0 mV. The precise IEP value may be computed via interpolation between the pH values at which the zeta potential transitions from positive to negative.

A liquid carrier is generally used to facilitate the application of the aminosilane modified silica coated ceria particles and any optional chemical additives to the surface of the substrate to be polished. The liquid carrier may include any suitable carrier (e.g., a solvent) including lower alcohols (e.g., methanol, ethanol, etc.), ethers (e.g., dioxane, tetrahydrofuran, etc.), water, and mixtures thereof. Preferably, the liquid carrier comprises, consists essentially of, or consists of water, more preferably deionized water.

The polishing composition is generally acidic having a pH of less than about 7 (e.g., about 6.5 or less, about 6 or less, about 5.5 or less, or about 5 or less). The polishing composition may have a pH of about 2 or more (e.g., about 2.5 or more, about 3 or more, or about 3.5 or more). Accordingly, the polishing composition may have a pH in a range bounded by any two of the aforementioned endpoints, for example, in a range from about 2 to about 7 (e.g., from about 2 to about 6, from about 3 to about 6, or from about 3.5 to about 5.5).

The pH of the polishing composition may be achieved and/or maintained by any suitable means. The polishing composition may include substantially any suitable pH adjusting agents or buffering systems. For example, suitable pH adjusting agents may include acetic acid, nitric acid, ammonium hydroxide, potassium hydroxide, triethanolamine, and the like while suitable buffering agents may include phosphates, sulfates, acetates, malonates, oxalates, borates, ammonium salts, and the like.

The disclosed polishing compositions may further optionally include substantially any suitable chemical mechanical polishing additives, for example, including a topography control agent, a silicon oxide polishing rate accelerator, a dispersant, and/or a biocide.

In example embodiments a topography control agent may include a cationic polymer. The cationic polymer may include substantially any suitable cationic polymer, for example, a cationic homopolymer, a cationic copolymer including at least one cationic monomer (and an optional nonionic monomer), and combinations thereof.

A cationic polymer may include substantially any suitable cationic homopolymer including cationic monomer repeat units, for example, including quaternary amine groups as repeat units. Suitable quaternary amine monomers include, for example, quaternized vinylimidazole (vinylimidazolium), methacryloyloxyethyltrimethylammonium (MADQUAT), diallyldimethylammonium (DADMA), methacrylamidopropyl trimethylammonium (MAPTA), quaternized dimethylaminoethyl methacrylate (DMAEMA), epichlorohydrin-dimethylamine (epi-DMA), cationic poly(vinyl alcohol) (PVOH), quaternized hydroxyethylcellulose, and combinations thereof. It will be appreciated that MADQUAT, DADMA, MAPTA, and DMAEMA commonly include a counter anion such as a carboxylate (e.g., acetate) or a halide anion (e.g., chloride). The disclosed embodiments are not limited in this regard.

The cationic polymer may also be a copolymer including at least one cationic monomer (e.g., as described in the preceding paragraph) and at least one nonionic monomer. Non-limiting examples of suitable nonionic monomers include vinylpyrrolidone, vinylcaprolactam, vinylimidazole, acrylamide, vinyl alcohol, polyvinyl formal, polyvinyl butyral, poly(vinyl phenyl ketone), vinylpyridine, polyacrolein, cellulose, hydroxylethyl cellulose, ethylene, propylene, styrene, and combinations thereof.

Example cationic polymers include but are not limited to poly(vinylimidazolium), poly(methacryloyloxyethyltrimethylammonium), (polyMADQUAT), poly(diallyldimethylammonium) (e.g., polyDADMAC) (i.e., Polyquaternium-6), poly(dimethylamine-co-epichlorohydrin), polybis(2-chloroethyl) ether-alt-1,3-bis[3-(dimethylamino)propyl]urea] (i.e., Polyquaternium-2), poly((methacryloylamino)propyl]trimethylammonium) (polyMAPTAC), copolymers of hydroxyethyl cellulose and diallyldimethylammonium (i.e., Polyquaternium-4), copolymers of acrylamide and diallyldimethylammonium (i.e., Polyquaternium-7), quaternized hydroxyethylcellulose ethoxylate (i.e., Polyquaternium-10), copolymers of vinylpyrrolidone and quaternized dimethylaminoethyl methacrylate (i.e., Polyquaternium-11), copolymers of vinylpyrrolidone and quaternized vinylimidazole (i.e., Polyquaternium-16), Polyquaternium-24, a terpolymer of vinylcaprolactam, vinylpyrrolidone, and quaternized vinylimidazole (i.e., Polyquarternium-46), 3-Methyl-1-vinylimidazolium methyl sulfate-N-vinylpyrrolidone copolymer (i.e., Polyquaternium-44), and copolymers of vinylpyrrolidone and diallyldimethylammonium. Additionally, suitable cationic polymers include cationic polymers for personal care such as Luviquat® Supreme, Luviquat® Hold, Luviquat® UltraCare, Luviquat® FC 370, Luviquat® FC 550, Luviquat® FC 552, Luviquat® Excellence, GOHSEFIMER K210™, GOHSENX K-434, and combinations thereof.

The cationic polymer may also include an amino acid monomer (such compounds may also be referred to as polyamino acid compounds). Suitable polyamino acid compounds may include substantially any suitable amino acid monomer groups, for example, including polyarginine, polyhistidine, polyalanine, polyglycine, polytyrosine, polyproline, and polylysine. In certain embodiments, polylysine is a preferred polyamino acid. It will be understood that polylysine may include ε-polylysine and/or α-polylysine composed of D-lysine and/or L-lysine. The polylysine may thus include α-poly-L-lysine, α-poly-D-lysine, ε-poly-L-lysine, ε-poly-D-lysine, and mixtures thereof. In certain embodiments, the polylysine may be ε-poly-L-lysine. It will further be understood that the polyamino acid compound (or compounds) may be used in any accessible form, e.g., the conjugate acid or base and salt forms of the polyamino acid may be used instead of (or in addition to) the polyamino acid.

The cationic polymer may also (or alternatively) include a derivatized polyamino acid (i.e., a cationic polymer containing a derivatized amino acid monomer unit). For example, the derivatized polyamino acid may include derivatized polyarginine, derivatized polyornithine, derivatized polyhistidine, and derivatized polylysine. CMP compositions including derivatized polyamino acid compounds are disclosed in commonly assigned U.S. Pat. No. 11,492,514.

In certain advantageous embodiments, the cationic polymer may include poly(methacryloyloxyethyltrimethylammonium) (e.g., Alco 4773), poly(diallyldimethylammonium) (e.g., polyDADMAC), polylysine (e.g., ε-poly-L-lysine), or mixtures thereof.

The polishing composition may include substantially any suitable amount of the cationic polymer. In general, the concentration is desirably high enough to provide adequate topography control, but low enough so that the polymer is soluble and so as not to reduce the polishing rates below acceptable levels. In example embodiments that include a cationic polymer, the concentration of the cationic polymer in the polishing composition may be in a range from about 0.1 ppm by weight to about 100 ppm by weight at point of use (e.g., from about 0.5 ppm to about 50 ppm, from about 2 ppm to about 20 ppm, or from about 2 ppm to about 10 ppm).

In example embodiments a polishing rate accelerator may include a nitrogen containing organic acid such as a suitable hydroxamic acid compound or a nitrogen-containing heterocyclic acid compound. Example rate enhancers may include, for example, picolinic acid, nicotinic acid, quinaldic acid, iso-nicotinic acid, quinolinic acid, benzhydroxamic acid, salicylhydroxamic acid, and mixtures thereof.

The polishing composition may include substantially any suitable amount of polishing rate accelerator. In general, the concentration is desirably high enough to provide sufficient rate enhancement, but low enough to not cause other undesirable polishing effects. In example embodiments that include a nitrogen containing organic acid, the concentration of the a nitrogen containing organic acid in the polishing composition may be in a range from about 10 ppm by weight to about 2 weight percent (20,000 ppm) at point of use (e.g., from about 100 ppm to about 10,000 ppm, from about 200 ppm to about 5000 ppm, or from about 300 ppm to about 3000 ppm).

The polishing composition may optionally further include a biocide. The biocide may include any suitable biocide, for example an isothiazolinone biocide. The amount of biocide in the polishing composition typically is in a range from about 1 ppm to about 50 ppm by weight at point of use or in a concentrate, and preferably from about 1 ppm to about 20 ppm.

In the disclosed embodiments, aminosilane modified silica coated ceria particles may be prepared, for example, by forming a silica coating on outer surfaces of ceria particles in (e.g., dispersed in) a liquid carrier to obtain silica coated ceria particles (e.g., a dispersion thereof) and modifying the silica coated ceria particles with an aminosilane compound to obtain a dispersion of positively charged aminosilane modified silica coated ceria particles. In one example process, a TEOS ethanol mixture may be slowly added to a heated ceria dispersion to form a Stöber silica coating on the ceria particles. After distillation to remove the ethanol, a sufficient amount of the aminosilane compound may be admixed with a predetermined volume (or mass) of the silica coated ceria dispersion. In other example processes, other silicon sources such as TMOS, silicic acid, or a silicate may be used. The admixture may optionally be heated to promote a condensation reaction between the silane group(s) in the modifying aminosilane compound and surface silanol group(s) on the silica coating. After cooling to room temperature (or after sufficient time in an unheated process), the resulting dispersion (including the modified colloidal silica particles) may optionally be passed through an ion exchange column to remove any unreacted aminosilane compound (or other impurities).

The polishing composition may then be prepared using any suitable techniques, many of which are known to those skilled in the art. For example, the polishing composition components (such as the cationic polymer, the nitrogen containing organic acid, and/or the biocide) may mixed together with an appropriate amount of water. A dispersion of the aminosilane modified silica coated ceria particles may then be added to and blended with the mixture. Substantially any suitable blending techniques may be used for achieving adequate mixing. Such blending/mixing techniques are well known to those of ordinary skill in the art.

The polishing composition may advantageously be supplied as a one-package system comprising the aminosilane modified silica coated ceria particles having the above described physical properties and the other optional components. However, the disclosed embodiments are not limited in this regard as various other two-container, or three- or more-container, combinations of the components of the polishing composition are within the knowledge of one of ordinary skill in the art. For example, the aminosilane modified silica coated ceria particles may be provided in a first container and one or more of the optional additives may be provided in a second container.

The polishing composition of the invention may also be provided as a concentrate which is intended to be diluted with an appropriate amount of water prior to use. In such concentrated embodiments, the polishing composition concentrate may include the aminosilane modified silica coated ceria particles, water, and other optional components in amounts such that, upon dilution of the concentrate with an appropriate amount of water each component of the polishing composition will be present in the polishing composition in an amount within the appropriate ranges recited above for each component. For example, the treated composite particles and other optional components may each be present in the polishing composition in an amount that is about 2 times (e.g., about 3 times, about 4 times, about 5 times, or even about 10 times) greater than the point of use concentrations recited above for each component so that, when the concentrate is diluted with an equal volume of (e.g., 2 equal volumes of water, 3 equal volumes of water, 4 equal volumes of water, or even 9 equal volumes of water respectively), each component will be present in the polishing composition in an amount within the ranges set forth above for each component. Furthermore, as will be understood by those of ordinary skill in the art, the concentrate may contain an appropriate fraction of the water present in the final polishing composition in order to ensure that other components are at least partially or fully dissolved in the concentrate.

The disclosed polishing compositions may be used to polish substantially any substrate, for example, including a dielectric layer such as a silicon oxide layer. Certain advantageous embodiments may be particularly useful in the polishing a dielectric layer at high removal rates and low defectivity levels (e.g., low scratch counts and low surface roughness). The dielectric layer may be a metal oxide such as a silicon oxide layer derived from tetraethylorthosilicate (TEOS), porous metal oxide, porous or non-porous carbon doped silicon oxide, fluorine-doped silicon oxide, glass, organic polymer, fluorinated organic polymer, or any other suitable high or low-k insulating layer.

The polishing method of the invention is particularly suited for use in conjunction with a chemical mechanical polishing (CMP) apparatus. Typically, the apparatus includes a platen, which, when in use, is in motion and has a velocity that results from orbital, linear, or circular motion, a polishing pad in contact with the platen and moving with the platen when in motion, and a carrier that holds a substrate to be polished by contacting and moving relative to the surface of the polishing pad. The polishing of the substrate takes place by the substrate being placed in contact with the polishing pad and the polishing composition of the invention and then the polishing pad moving relative to the substrate, so as to abrade at least a portion of the substrate (such as a dielectric material as described herein) to polish the substrate.

A substrate may be planarized or polished with the chemical mechanical polishing composition with any suitable polishing pad (e.g., polishing surface). Suitable polishing pads include, for example, woven and non-woven polishing pads. Moreover, suitable polishing pads can comprise any suitable polymer of varying density, hardness, thickness, compressibility, ability to rebound upon compression, and compression modulus. Suitable polymers include, for example, polyvinylchloride, polyvinylfluoride, nylon, fluorocarbon, polycarbonate, polyester, polyacrylate, polyether, polyethylene, polyamide, polyurethane, polystyrene, polypropylene, co-formed products thereof, and mixtures thereof.

The following examples further illustrate the invention but, of course, should not be construed as in any way limiting its scope.

### Example 1

Silica coated ceria particle dispersions were prepared. The silica coated ceria particles had theoretical silica coating thicknesses of 2 nm, 4 nm, or 8 nm and aminosilane modification levels of 0 percent, 6 percent, or 20 percent. The preparation procedure for these dispersions was as follows. Potassium citrate and deionized water were admixed with a stock ceria dispersion having a BET surface area of about 13 m²/g (the stock ceria dispersion was prepared as described in Example 1 of commonly assigned U.S. Patent Publication 2021/0115298) to obtain an admixture including 150 ppm of potassium citrate and about 4.3 weight percent ceria. The pH of the admixture was adjusted to 10.5 using about 3 grams of ethyloxypropylamine. The admixture was sonicated and then heated in a reactor to 75 degrees C. with stirring at 250 rpm. A mixture of TEOS and ethanol was slowly added to the reactor. To obtain a theoretical silica coating thickness of 2 nm, 19 grams of TEOS was added to 4932 grams of the ceria admixture (39 grams and 83 grams of TEOS were added to obtain theoretical silica coating thicknesses of 4 nm and 8 nm).

After a reaction time of 10 hours, the reaction product was allowed to slowly cool. Ethanol was removed via distillation and deionized water was back added. The resulting silica coated ceria dispersions were then passed through a mixed bed ion exchange column. The resulting dispersions included about 4.5 weight percent of the silica coated ceria particles and had pH values in a range from 8.5 to 9 and a conductivities ranging from about 12 to 16 μS.

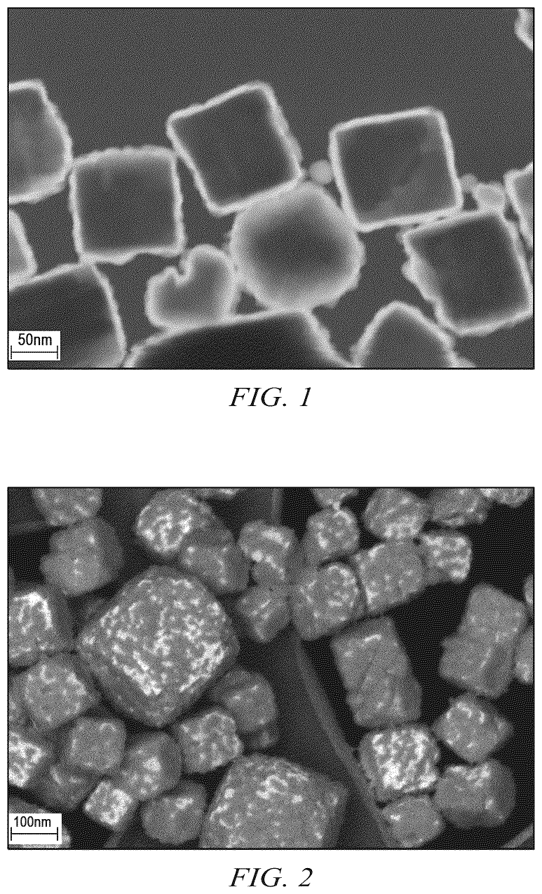

Deionized water was added to reduce the concentrations of the silica coated ceria particles to about 4 weight percent. A solution of 1 weight percent APTMS was added with stirring (the amount based upon the target modification level). The pH was adjusted to 10 using KOH. The reaction vessel was heated to 75 degrees C. with stirring and held for 20 hours. The reaction product was allowed to slowly cool to room temperature and was then passed through a cationic ion exchange column. The resulting dispersions included about 3.6 weight percent of the aminosilane modified silica coated ceria particles and had pH values of about 4 and conductivities of about 50 μS. FIGS. 1 and 2 show STEM and SEM micrographs of example particles having a theoretical silica coating thicknesses of 8 nm. In FIG. 1, the silica coating appears as a light coating on the dark ceria particles and appears to cover most or all of the outer surface of the ceria. In both FIGS. 1 and 2 it is evident that the silica coating is not perfectly uniform and may include small bumps or nodules.

### Example 2

The zeta potential and IEP of silica coated ceria particle dispersions were evaluated. Control composition 2A included the stock dispersion of Example 1. Control compositions 2B, 2C, and 2D included silica coated ceria particles having target (theoretical) silica coating thicknesses of 2 nm, 4 nm, and 8 nm. Composition 2E included aminosilane modified silica coated ceria particles having a target (theoretical) silica coating thickness of 2 nm and a target (theoretical) aminosilane modification level of 6 percent. Compositions 2F, 2G, and 2H included aminosilane modified silica coated ceria particles having target (theoretical) silica coating thicknesses of 2 nm, 4 nm, and 8 nm and a target (theoretical) aminosilane modification level of 20 percent. The silica coating thicknesses and aminosilane modification levels of compositions 2A-2H are shown in Table 1A.

TABLE 1A

| | Coating | Modification |
|---|---|---|
| Composition | Thickness (nm) | Level (%) |
| 2A | 0 | 0 |
| 2B | 2 | 0 |
| 2C | 4 | 0 |
| 2D | 8 | 0 |
| 2E | 2 | 6 |
| 2F | 2 | 20 |
| 2G | 4 | 20 |
| 2H | 8 | 20 |

The zeta potential (ZP) of each composition was measured using the Zetaprobe Analyzer® available from Colloidal Dynamics at pH values of 3, 4, 5, and 6. The IEP was also estimated using the procedure described above. The data are shown below in Table 1B.

TABLE 1B

| | ZP pH 3 | ZP pH 4 | ZP pH 5 | ZP pH 6 | |
|---|---|---|---|---|---|
| Composition | (mV) | (mV) | (mV) | (mV) | IEP |
| 2A | 97 | 91 | 94 | 98 | 9.7 |
| 2B | −39 | −67 | −75 | −79 | <2 |
| 2C | −8 | −29 | −52 | −61 | ~2.6 |
| 2D | 22 | 9 | −18 | −43 | 4.2 |
| 2E | −13 | −32 | −59 | −70 | ~2.3 |
| 2F | 99 | 94 | 91 | 60 | 7.3 |
| 2G | 98 | 94 | 91 | 61 | 7.3 |
| 2H | 101 | 95 | 87 | 54 | 7.1 |

As is readily apparent from the data set forth in Table 1B, compositions 2F, 2G, and 2H including aminosilane modified silica coated ceria particles with an aminosilane modification level of 20% have high positive zeta potentials similar to the starting ceria particles (composition 2A) at pH values of 3, 4, and 5. Compositions 2F, 2G, and 2H also have an IEP of greater than 7.

### Example 3

Four polishing compositions were prepared. Control compositions 3A and 3C included the same stock ceria particles evaluated in composition 2A. The control compositions included 0.286 weight percent (3A) and 0.143 weight percent (3C) of the ceria particles. Inventive compositions 3B and 3D included the aminosilane modified silica coated ceria particles evaluated in composition 2F. The inventive compositions included 0.286 weight percent (3B) and 0.143 weight percent (3D) of the aminosilane modified silica coated ceria particles. Compositions 3A-3D were otherwise identical and further included 1071 ppm picolinic acid, 5 ppm epsilon poly-L-lysine, 5 ppm troyshield FX-40 biocide. The target pH was 3.8.

Table 2A gives measured pH, conductivity, average particle size, and zeta potential values for each composition. The average particle size values were measured using a Horiba LA-960 Instrument. The zeta potentials were measured using the DT1202 from Dispersion Technology, Inc. with a Smoluchowski correction.

TABLE 2A

| Polishing | Measured | Conductivity | Particle | Zeta Potential |
|---|---|---|---|---|
| Composition | pH | (μS/cm) | Size (nm) | (mV) |
| 3A | 3.8 | 92 | 101 | 66 |
| 3B | 3.7 | 96 | 106 | 59 |
| 3C | 3.8 | 93 | 101 | 74 |
| 3D | 3.8 | 91 | 106 | 68 |

The CMP performance of polishing compositions 3A-3D was evaluated using a Mirra® CMP polishing tool (Applied Materials) with an E6088 polishing pad (Entegris) and in-situ conditioning using a Saesol DS8051 conditioner at 6 lbs. Blanket TEOS, HDP, PE-SiN, LP-SiN, and Poly rates were obtained by polishing 200 mm blanket wafers at a downforce of 3.0 psi, a platen speed of 100 rpm, a head speed of 85 rpm, and a slurry flow rate was 150 mL/min. Blanket wafer polishing rates (removal rates) are shown in Table 2B.

TABLE 2B

| | TEOS | HDP | PE-SiN | LP-SiN | Poly |
|---|---|---|---|---|---|
| Polishing | RR | RR | RR | RR | RR |
| Composition | (Å/min) | (Å/min) | (Å/min) | (Å/min) | (Å/min) |
| 3A | 6903 | 5589 | 17 | 6 | 76 |
| 3B | 7449 | 6105 | 29 | 14 | 47 |
| 3C | 6507 | 5408 | 17 | 6 | 28 |
| 3D | 5030 | 4165 | 22 | 9 | 34 |

As is apparent from the data set forth in Table 2B, the inventive compositions included comparable polishing rates to the control compositions. In particular, composition 3B exhibited a moderately improved polishing rate on TEOS and HDP blanket wafers as compared to control composition 3A.

### Example 4

Four polishing compositions were prepared. Control composition 4A included 0.2 weight percent of the stock ceria particles in composition 2A. Inventive composition 4B included 0.2 weight percent of the aminosilane modified silica coated ceria particles in composition 2F (having a having target silica coating thicknesses of 2 nm and a target aminosilane modification level of 20 percent). Control composition 4C included 0.2 weight percent of a wet process ceria having an average particle size of about 90 nm. Inventive composition 4D included 0.2 weight percent of aminosilane modified silica coated ceria particles prepared by forming a silica coating having a target thickness of 2 nm on the ceria particles used in composition 4C. The silica coating was further modified with APTMS at a target modification level of 20 percent. Silica coating growth and aminosilane modification were conducted according to the procedure described in Example 1. The pH was adjusted to 4.0 using acetic acid. The compositions included no further additives.

Table 3A gives conductivity, average particle size, and zeta potential values for each composition. The particle size values were measured using a Horiba LA-960 Instrument. The zeta potentials were measured using the DT1202 from Dispersion Technology, Inc. with a Smoluchowski correction.

TABLE 3A

| Polishing | Conductivity | Particle | Zeta Potential |
|---|---|---|---|
| Composition | (μS/cm) | Size (nm) | (mV) |
| 4A | 46 | 113 | 89 |
| 4B | 43 | 123 | 89 |
| 4C | 44 | 92 | 90 |
| 4D | 47 | 101 | 86 |

The CMP performance of polishing compositions 4A-4D was evaluated using a Mirra® CMP polishing tool (Applied Materials) with an E6088 polishing pad (Entegris) and in-situ conditioning using a Saesol C1 conditioner at 6 lbs. Blanket TEOS, PE-SiN, LP-SiN, and Poly rates were obtained by polishing 200 mm blanket wafers at a downforce of 3.0 psi, a platen speed of 100 rpm, a head speed of 85 rpm, and a slurry flow rate was 150 mL/min. Blanket wafer polishing rates (removal rates) are shown in Table 3B.

TABLE 3B

| Polishing | TEOS RR | PE-SiN RR | LP-SiN RR | Poly RR |
|---|---|---|---|---|
| Composition | (Å/min) | (Å/min) | (Å/min) | (Å/min) |
| 4A | 6589 | 19 | 580 | 420 |
| 4B | 6252 | 23 | 72 | 446 |
| 4C | 5004 | 12 | 660 | 322 |
| 4D | 4468 | 17 | 341 | 424 |

As is apparent from the data set forth in Table 3B, the inventive compositions achieved comparable TEOS polishing rates to the control compositions.

### Example 5

Two polishing compositions were prepared. Composition 5A included 0.3 weight percent the aminosilane modified silica coated ceria particles in composition 2F (having a target silica coating thicknesses of 2 nm and a target aminosilane modification level of 20 percent). Composition 5B included 0.3 weight percent the aminosilane modified silica coated ceria particles in composition 2G (having a target silica coating thicknesses of 4 nm and a target aminosilane modification level of 20 percent). The compositions were otherwise identical and further included 250 ppm picolinic acid and 5 ppm troyshield FX-40 biocide. The target pH was 4.5.

The CMP performance of polishing compositions 5A-5B was evaluated using a Mirra® CMP polishing tool (Applied Materials) with an E6088 polishing pad (Entegris) and in-situ conditioning using a Saesol DS8051 conditioner at 6 lbs. Blanket TEOS, PE-SiN, and LP-SiN, were obtained by polishing 200 mm blanket wafers at a downforce of 3.0 psi, a platen speed of 100 rpm, a head speed of 85 rpm, and a slurry flow rate was 150 mL/min. Blanket wafer polishing rates (removal rates) are shown in Table 4.

TABLE 4

| Polishing | TEOS RR | PE-SiN RR | LP-SiN RR |
|---|---|---|---|
| Composition | (Å/min) | (Å/min) | (Å/min) |
| 5A | 6361 | 15 | 12 |
| 5B | 6707 | 24 | 16 |

As is apparent from the data set forth in Table 4, compositions 5A and 5B both achieved high TEOS polishing rates.

### Example 6

Two polishing compositions were prepared. Control composition 6A included 0.2 weight percent of a wet process ceria having an average particle size of about 95 nm. Inventive composition 6B included 0.2 weight percent of aminosilane modified silica coated ceria particles prepared by forming a silica coating having a target thickness of 4 nm on the ceria particles used in composition 6A. The silica coating was further modified with APTMS at a target modification level of 20 percent. Silica coating growth and aminosilane modification were conducted according to the procedure described in Example 1. The pH was adjusted to 4.0 using acetic acid. The compositions included no further additives.

Table 5A gives conductivity, average particle size, and zeta potential values for each composition. The particle size values were measured using a Horiba LA-960 Instrument. The zeta potentials were measured using the DT1202 from Dispersion Technology, Inc. with a Smoluchowski correction.

TABLE 5A

| Polishing | Conductivity | Particle | Zeta Potential |
|---|---|---|---|
| Composition | (μS/cm) | Size (nm) | (mV) |
| 6A | 43 | 95 | 79 |
| 6B | 49 | 95 | 77 |

The CMP performance of polishing compositions 6A and 6B was evaluated using a Mirra® CMP polishing tool (Applied Materials) with an E6088 polishing pad (Entegris) and in-situ conditioning using a Saesol C1 conditioner at 6 lbs. Polishing removal rates were obtained by polishing 200 mm blanket and patterned TEOS wafers at a downforce of 3.0 psi, a platen speed of 100 rpm, a head speed of 85 rpm, and a slurry flow rate was 150 mL/min. The surface roughness on the polished TEOS wafers was also evaluated using an atomic force microscope (AFM). Blanket wafer polishing rates (removal rates) and surface roughness are shown in Table 5B. Pattern removal rates are shown in Table 5C for 100×100 μm, 200×200 μm, 450×450 μm, and 900×900 μm line features.

TABLE 5B

| Polishing | TEOS RR | Ra | Rq |
|---|---|---|---|
| Composition | (Å/min) | (Å) | (Å) |
| 6A | 7052 | 2.3 | 1.8 |
| 6B | 6074 | 1.9 | 1.5 |

TABLE 5C

| | 100 × | 200 × | 450 × | 900 × |
|---|---|---|---|---|
| Polishing | 100 μm | 200 μm | 450 μm | 900 μm |
| Composition | RR (Å/min) | RR (Å/min) | RR (Å/min) | RR (Å/min) |
| 6A | 4187 | 4453 | 4339 | 4123 |
| 6B | 5571 | 6053 | 6254 | 6175 |

As is evident from the results set forth in Tables 5B and 5C, polishing composition 6B including the aminosilane modified silica coated ceria particles exhibited superior (lower) surface roughness and significantly higher patterned removal rates over a range of line feature sizes (from 100×100 μm to 900×900 μm).

It will be understood that the recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A chemical mechanical polishing composition comprising:
a liquid carrier;
silica coated ceria particles in the liquid carrier, the silica coated ceria particles having a silica coating over a ceria core;
an aminosilane compound covalently bonded to an external surface of the silica coating such that the silica coated ceria particles have a positive charge in the polishing composition; and
a pH of less than about 7.

2. The composition of claim 1, comprising from about 0.01 weight percent to about 1 weight percent of the silica coated ceria particles at point of use.

3. The composition of claim 1, wherein the silica coated ceria particles have a number average particle size in a range from about 20 nm to about 200 nm.

4. The composition of claim 1, wherein the ceria core comprises wet process ceria, precipitated ceria, fumed ceria, calcined ceria, condensation polymerized ceria, or a mixture thereof.

5. The composition of claim 1, wherein the silica coating has a thickness in a range from about 1 nm to about 10 nm.

6. The composition of claim 1, wherein the silica coated ceria particles have a theoretical amount of silicon in the silica coating from about 1×10⁻⁵ moles of silicon to about 1×10⁻³ moles of silicon per square meter of surface area of the silica coated ceria particles.

7. The composition of claim 1, wherein the silica coating comprises Stuber silica.

8. The composition of claim 1, wherein the silica coated ceria particles have a total metals impurity of less than 20 ppm, wherein the metals consist of sodium, aluminum, calcium, magnesium, and the transition metals.

9. The composition of claim 1, wherein the silica coated ceria particles have a zeta potential in the polishing composition of greater than about 30 mV as measured using an electroacoustic analyzer.

10. The composition of claim 9, wherein the silica coated ceria particles have a zeta potential in the polishing composition of greater than about 50 mV as measured using an electroacoustic analyzer.

11. The composition of claim 1, wherein the aminosilane compound comprises a propyl group, a primary amine, or quaternary amine.

12. The composition of claim 11, wherein the aminosilane compound comprises a multi-podal aminosilane.

13. The composition of claim 1, wherein the silica coated ceria particles have a modification level of the aminosilane compound of at least about 10 percent.

14. The composition of claim 1, further comprising a nitrogen containing organic acid.

15. The composition of claim 1, further comprising a nitrogen-containing heterocyclic compound.

16. The composition of claim 1, further comprising a cationic polymer.

17. The composition of claim 16, wherein the cationic polymer comprises polylysine, poly(methacryloyloxyethyltrimethylammonium), poly(diallyldimethylammonium), or a mixture thereof.

18. The composition of claim 1, wherein the pH is in a range from about 3 to about 6.

19. A method of chemical mechanical polishing a substrate, the method comprising:
contacting the substrate with a polishing composition comprising:
a liquid carrier;
silica coated ceria particles in the liquid carrier, the silica coated ceria particles having a silica coating over a ceria core;
an aminosilane compound covalently bonded to an external surface of the silica coating such that the silica coated ceria particles have a positive charge in the polishing composition; and
a pH of less than about 7;
moving the polishing composition relative to the substrate; and
abrading the substrate to remove at least a portion of a dielectric material from the substrate and thereby polish the substrate.
